(19) United States
(12) Patent Application Publication
(10) Pub. No.: US 2012/0290969 A1
(43) Pub. Date: Nov. 15, 2012

(54) MULTI-STAGE METHOD AND APPARATUS FOR INTERACTIVELY LOCATING DEVICE DATA OF AN AUTOMATION SYSTEM

(75) Inventor: Daniel GROSSMANN, Schriesheim (DE)

(73) Assignee: ABB Technology AG, Zurich (CH)

(21) Appl. No.: 13/469,908

(22) Filed: May 11, 2012

(30) Foreign Application Priority Data
May 11, 2011 (DE) 102011101146.7

(51) Int. Cl. G06F 3/048

(52) U.S. Cl. 715/780

(57) ABSTRACT

A method for the multi-stage interactive locating and utilizing of device data in a networked automation system is provided. A user inputs from a central location in a graphical search field of an input mask displayed by an information fetching unit a designation of a field device present in the communication network of the automation system. During the input of the designation into the search field, the information fetching unit generates and displays fitting hit designations of field devices actually present in the automation system in an associated result list. After selection of the required field device, at least one further supplementary search criterion relating to the selected field device is entered into a search field of the input mask in a refinement step, and the device data corresponding to the supplementary search criterion for the required field device is displayed after subsequent start of the search by the user.

### RELATED APPLICATION

This application claims priority under 35 U.S.C. §119 to German Patent Application No. 102011101146.7 filed in Germany on Nov. 5, 2011, the entire content of which is hereby incorporated by reference in its entirety.

### FIELD

The present disclosure relates to a method and to an apparatus for the multi-stage interactive locating and utilizing of device data in a networked automation system in which a user inputs from a central location, by inputting in a graphic search field of an input mask displayed by a monitor of an information-providing unit, a designation of a field device data item present in the communication network of the automation system. Furthermore, the present disclosure relates to a non-transitory computer-readable recording medium having a computer program recorded thereon that causes a processor of the information providing unit to carry out the method.

### BACKGROUND INFORMATION

The field of application of the present disclosure extends to automation systems in the context of industrial plants, for example, process engineering. To control the sequences of the process, devices are used such as valves as actuators, sensors and the like which communicate with a higher-level controller and one another by field bus. Such field devices have integrated electronic units for bus linkage and for local data processing. In modern automation systems which use a field bus protocol for communication, higher levels of the field device information are integrated in order to modernize operating processes, improve process and product quality and maximize the availability. To this extent, configuration, parameterization and diagnostic functions of the control system also relate to the field devices. In the context of the present disclosure, the term field device thus relates to many actuators, sensors, analysis devices and low-voltage devices which can be integrated into an automation system via a bus connection. By using intelligent field devices and with the utilization of modern field bus protocols, a multiplicity of functions can be implemented in the system such as operating functions, commissioning functions, diagnostic functions, maintenance functions, optimization functions, alarm processing functions and service-life monitoring functions, for example.

This results in the trend that field devices become more and more complex and intelligent in structure and in range of functions. This finds expression in a rising number of parameters of the field devices. These parameters occur in a large variety of device data such as especially in the device master data or in the device description.

This situation increasingly results in the problem for the user that the quantity of such and similar device data increases with the size and complexity of the automation system and can become confusing. In the interests of operational safety, it is important that device data are available completely and currently always retrievable for the user. In the case of device descriptions, these are usually provided in the form of a database file of the field device. For PROFIBUS devices, the device manufacturer supplies these device databases as so-called GSD or EDD files, among others. However, it is also conceivable that device data are deposited stored in a device management database at a central point which database contains for each field device present in the automation system information about its technical parameters, manufacturer's data, configuration data and operating instructions.

Due to the structure, it is increasingly difficult and time-consuming for the user to locate current device data especially of interest to him in the automation system at all and then to process these or be able to use them otherwise. If a software-controlled search function is used for this, such a search presupposes accurate knowledge of the syntax of device identifications for the unambiguous identification of a field device of the automation system. Even if a search result has been achieved, it is not certain that the search result achieved actually relates to the field device of interest.

### SUMMARY

An exemplary embodiment of the present disclosure provides a method for the multi-stage interactive locating and utilizing of device data in a networked automation system. The exemplary method includes receiving, by a user, an input from a central location by keyboard in a graphical search field of an input mask displayed by a monitor of an information fetching unit, a designation of a field device present in the communication network of the automation system. The exemplary method also includes generating and displaying, in the information fetching unit, during the input of the designation into the search field, fitting hit designations of field devices actually present in the automation system in an associated result list. In addition, the exemplary method includes receiving, in the input mask of the information fetching unit, a selection of the required field device, and after selection of the required field device, receiving, in the information fetching unit, at least one further supplementary search criterion relating to the selected field device entered into at least one of the search field and an adjacent refinement search field of the input mask in a subsequent refinement. The exemplary method also includes, based on the received further supplementary search criterion, selectively displaying the device data corresponding to the supplementary search criterion for the required field device after subsequent start of the search by the user.

An exemplary embodiment of the present disclosure provides an apparatus for the multi-stage interactive locating and utilizing of device data in a networked automation system. The exemplary apparatus includes an information fetching unit having an input means, a monitor configured to display an input mask including a graphical search field. The information fetching unit is confgiured to: receive a designation input by a user via the input means to the graphical search field of the input mask displayed by the monitor, a field device present in the communication network of the automation system; generate and display, during the input of the designation into the search field, fitting hit designations of field devices actually present in the automation system, in an associated result list; receive at least one further supplementary search criterion relating to the selected field device into at least one of the search field and an adjacent refinement search field of the input mask; and based on the received further supplementary search criterion, display the device data corresponding to the supplementary search criterion for the required field device selectively after the start of the search by the user.

An exemplary embodiment of the present disclosure provides a non-transitory computer-readable recording medium having a computer program recorded thereon that causes a processor of an information fetching unit to execute operations for the multi-stage interactive locating and utilizing of device data in a networked automation system. The operations include: receiving, by a user, an input from a central location by keyboard in a graphical search field of an input mask displayed by a monitor of the information fetching unit, a designation of a field device present in the communication network of the automation system; generating and displaying fitting hit designations of field devices actually present in the automation system in an associated result list; receiving, in the input mask, a selection of the required field device; after selection of the required field device, receiving at least one further supplementary search criterion relating to the selected field device entered into at least one of the search field and an adjacent refinement search field of the input mask in a subsequent refinement; and based on the received further supplementary search criterion, selectively displaying the device data corresponding to the supplementary search criterion for the required field device after subsequent start of the search by the user.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a diagrammatic representation of a networked automation system having an information fetching unit for the multi-stage interactive locating and utilizing of device data, according to an exemplary embodiment of the present disclosure; and

FIG. 2 shows a diagrammatic representation of an input mask of the information fetching unit according to FIG. 1.

### DETAILED DESCRIPTION

Exemplary embodiments of the present disclosureprovide a reliably functioning means for locating and utilizing device data in a networked automation system which is capable of taking device data of a multiplicity of field devices to an unambiguous and correct search result via which the user can obtain direct access to the content for display for processing or the like, independently of the actual storage location of the device data.

An exemplary embodiment of the present disclosure provides a method for the multi-stage interactive locating and utilizing of device data in a networked automation system in which a user inputs, from a central location by keyboard in a graphical search field of an input mask displayed by a monitor of an information fetching unit, a designation of a field device present in the communication network of the automation system. In the exemplary embodiment, the information fetching unit, during the input of the designation into the search field, generates and displays fitting hit designations of field devices actually present in the automation system in an associated result list. After selection of the required field device in a selection step, at least one further supplementary search criterion relating to the selected field device is entered into the search field or an adjacent refinement search field of the input mask in a subsequent refinement step in order to selectively display the device data corresponding to the supplementary search criterion for the required field device after subsequent start of the search by the user.

An exemplary embodiment of the present disclosure provides an apparatus for the multi-stage interactive locating and utilizing of device data in a networked automation system. The apparatus includes an information fetching unit configured to receive a designation, which can be input by the user by a keyboard in a graphical search field of an input mask displayed via a monitor of the information fetching unit, of a field device present in the communication network of the automation system. The information fetching unit is configured to generate and display, during the input of the designation into the search field, fitting hit designations of field devices actually present in the automation system, in an associated result list. The information fetching unit is also configured to receive, via the input mask, an input for at least one further supplementary search criterion relating to the selected field device or an adjacent refinement search field of the input mask, and display the device data corresponding to the supplementary search criterion for the required field device selectively after the start of the search by the user.

Exemplary embodiments of the present disclosure provide the technical teaching that an information fetching unit of the automation system generates and displays, during the input of a designation into the search field, in a result list associated with the search field, fitting hit designations of field devices actually present in the automation system wherein, after selection of the required field device from the result list in a selection step, at least one further supplementary search criterion relating to the selected field device is entered into the search field or an adjacent refinement search field of the input mask during a subsequent refinement step in order to selectively display, after the subsequent start of the search by action of the user, the device data corresponding to the supplementary search criterion for the required field device, for example, from a device management database.

For the selectable display of the device data as a result of this special multi-stage interactive locating method, the information fetching unit can either analyze device data stored locally in individual field devices or access a central device management database in which all device data of the automation system are collected. These features according to the present disclosure enable the required device data to be located in a simple and intuitive manner in complex automation systems without the user needing to know the location at which the required device data are stored.

The designation of the device which must be input for this purpose can be, for example, the equipment identity predetermined by the manufacturer, which can be a sequence of numbers and letters. In this context, each designation is specified unambiguously in order to be applicable as unambiguous search criterion. The supplementary search criterion to be input additionally and only in a further selection step identifies in a similar manner a specification of the device relating to the selected device, for example device parameters, manual of the device, process data on the device.

To input the supplementary search criterion into the search field, fitting hit designations of specifications actually present in the automation system and corresponding to the supplementary search criterion can be generated and displayed in an associated further result list. This further simplifies the locating of the required device data.

To achieve better manageability of the multi-stage interactive locating method, the selected hit designation can be displayed in a separate refinement search field, and the supplementary search criterion is input in the form of a suffix to this. In this context, the supplementary search criterion can be displayed here, analogously to the preceding selection step, in a result list associated with the refinement search field in the sense of a preselection. The device data corresponding to the supplementary search criterion of the required field device can finally be displayed, for example, in the form of an event representation field linked to the device data by a link. This provides the user with the option of accessing the search result, for example, the service manual of the field device, stored as a file, directly before the representation of the result, in order to utilize its content.

According to an exemplary embodiment of the present disclosure, for a facilitated visual perception of the search result, the device data displayed in the event representation field can in each case be associated with pictograms for optical identification. These pictograms can represent, for example, the device type of the field device, that is to say be a sensor symbol, valve symbol and the like. Apart from this, it is also conceivable that pictograms are represented for the optical identification of the file format of the device data, for example, a PDF file or parameter input mask and the like.

Selecting the search result thus provides the user with the option of, for example, reaching through directly from the result representation to the user interface of the field device, that is to say opening the latter in order to be able to change, for example, the device parameters.

In the context of the bus-controlled automation system, the multi-stage method according to the present disclosure for interactively locating the device data can be implemented by a processor of the information fetching unit executing a computer program tangibly recorded on a non-transitory computer-readable recording (e.g., a non-volatile memory), wherein the routine for locating the required device data can be implemented by the processor executing corresponding control commands stored in an item of software. The subject matter of the solution according to the disclosure is not only the locating of data records previously deposited in the system, possibly stored in a central data management database but, in addition, also the implementation of a direct access to a device parameterization and the like on the field device via the industrial communication protocol, namely directly on the basis of the search result. Further intermediate method steps or even the utilization of another system unit provided especially for the parameterization can be omitted as a result which renders the operating processes in the automation system more rapid and more reliable.

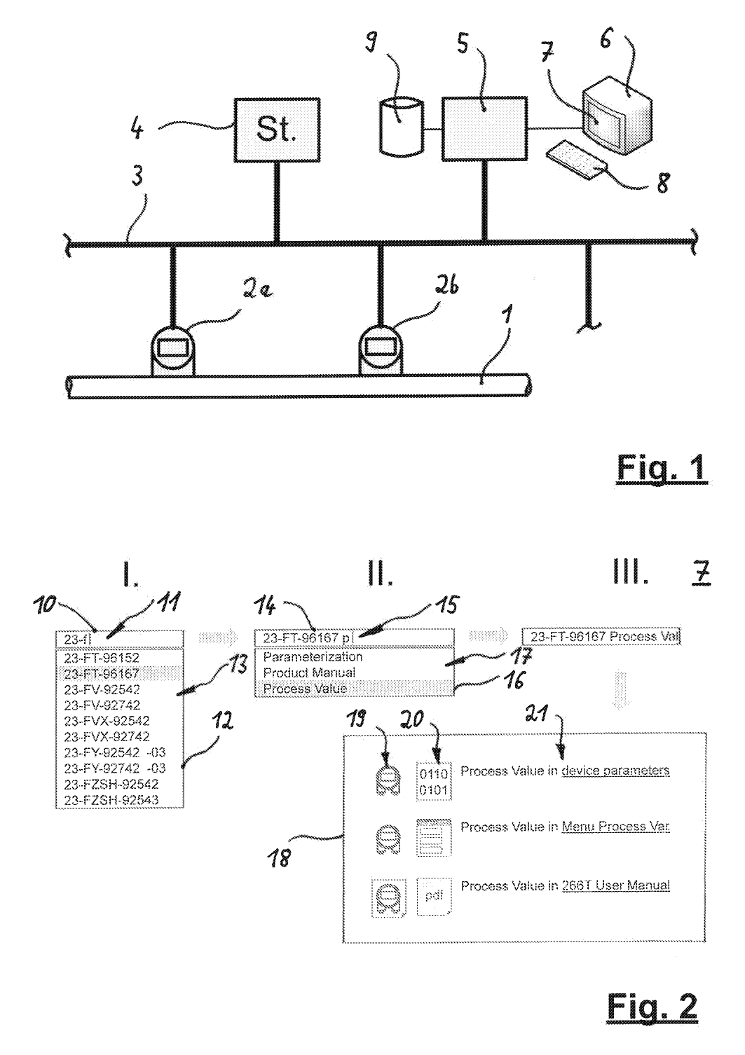

According to an exemplary embodiment as illustrated in FIG. 1, an automation system of a process engineering plant includes a number of field devices 2a and 2b, arranged on an exemplary pipeline 1, which in this case represent flow meters by way of example. The field devices 2a and 2b are connected to a communication network 3 via an integrated bus interface in order to pass on determined measurement data to a central processing unit 4 via the communication network 3 as determined by a bus protocol, for example. Furthermore, the field devices 2a and 2b can also perform other functions such as self-test functions, service life counting functions and the like which can also be monitored via the communication network 3.

Apart from the central processing unit 4, a special information fetching unit 5 is also connected to the communication network 3 of the automation system. The information fetching unit 5 is used for locating, in a multi-stage interactive manner, device data of all field devices 2a, 2b etc. present in the automation system and, in addition, provides for direct access to the communication interfaces at least of individual field devices 2a, 2b. For this purpose, the information fetching unit 5 includes a monitor 6 having an input mask 7, which is explained in greater deail below. The user can perform the aforementioned function of the information fetching unit 5 via an associated keyboard 8 with the aid of the input mask 7 by means of a processor in the information fetching unit 5 executing an interactive software application tangibly recorded on a non-transitory computer-readable recording medium (e.g., ROM, hard disk drive or other non-volatile memory). To locate device data, the information fetching unit 5 is connected to a device management database 9 in this exemplary embodiment. The device management database 9 contains, for each field device 2a, 2b etc. present in the automation system, information about their respective technical parameters, manufacturer's data, configuration data and operating instructions.

As illustrated in the exemplary embodiment of FIG. 2, the multi-stage interactive locating of required device data via the input mask 7 takes place in such a manner that in step I, the user begins to input the designation 11 of the field device 2a to be located via, for example, the keyboard 8 in a graphical search field 10 displayed via the input mask 7. During the input of the designation 11 into the search field 10, fitting hit designations (e.g., matching or similar search results) 13 of field devices 2a, 2b etc. actually present in the automation system are generated and displayed in an associated result list 12 via the information fetching unit 5 by accessing the device management database 9. This provides the user with a facilitated selection of the required field device 2a.

In a further step II, the field device 2a previously selected in the search field 10 is displayed with respect to its designation and the user can begin to input a supplementary search criterion 15 as a suffix, for example, in the refinement information field 14 of the input mask 7. The supplementary search criterion 15 begins here with the letter “P” and a preselection of fitting hit designations 17 is offered in a separate result list 16 associated with the refinement field 14. The result list 16 contains hit designations 17 of specifications actually present in the automation system and corresponding to the supplementary search criterion 15, in this example the parameterization belonging to the field device 2a, the user manual and the process values at the field device 2a.

If the search is started in step III by a key operation by the user, the information fetching unit 5, by accessing the device management database 9, selects the device data, corresponding to the designation 11 of the field device 2a including the supplementary search criterion 15 for the field device 2a. These device data 21 are displayed in list form in a result display field 18 and a pictogram 19 and 20 is allocated to each entry (by way of example). In this context, pictogram 19 designates the device type of the field device 2a, for example, a temperature sensor, and the pictogram 20 designates the file format of the respective device data 21, for example, PDF document, input mask and the like.

The device data 21 entered in list form in the result display field 18 can then be selected by the user in order to have direct access to the process values in the device parameters or to change the variables in an editing menu or to obtain information with regard to the process values in a user manual.

The present disclosure is not restricted to the exemplary embodiments described above; instead, modifications thereof are also conceivable which are also covered by the protective range of the subsequent claims. For example, it is thus also possible both to quickly locate, and read or process other field devices with regard to their device data by means of the method and apparatus according to the present disclosure.

In order to simplify speedy finding of field devices located in the network of the automation system further, the search fields of the input mask can also be equipped with other supplementary functions. Thus, it is possible, for example, to create a searchable history of the hit designations selected by the user in the past, or search terms entered in order to provide for faster access to frequently repeated inputs. This history can also be individualized according to the log-in identification of the user. By this mechanism, the user can either use entries from a list of histories for the input in the search field or, as previously proposed, fitting hits can be provided for selection from the list of histories with progressive input of a search term into a search field. The history can then be filtered via various categories of entry.

In addition, the user can also be provided with the option of depositing stored search terms frequently used in a list of favorites in order to obtain faster access to these without the search terms having to be entered continuously repeatedly via a keyboard. These and other functional extensions for the input mask can be suitably displayed on the monitor, the user being provided with the option of himself designing the type of graphical representation and the arrangement of the views.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE DESIGNATIONS

1 Pipeline

2 Field device

3 Communication network

4 Processing unit

5 Information fetching unit

6 Monitor

7 Input mask

8 Keyboard

9 Device management database

10 Search field

11 Designation

12,16 Result list

13,17 Hit designation

14 Refinement search field

15 Supplementary search criterion

18 Result representation field

19, 20 Pictogram

21 Device data

What is claimed is:

1. A method for the multi-stage interactive locating and utilizing of device data in a networked automation system, the method comprising:
receiving, by a user, an input from a central location by keyboard in a graphical search field of an input mask displayed by a monitor of an information fetching unit, a designation of a field device present in the communication network of the automation system;
generating and displaying, in the information fetching unit, during the input of the designation into the search field, fitting hit designations of field devices actually present in the automation system in an associated result list;
receiving, in the input mask of the information fetching unit, a selection of the required field device;
after selection of the required field device, receiving, in the information fetching unit, at least one further supplementary search criterion relating to the selected field device entered into at least one of the search field and an adjacent refinement search field of the input mask in a subsequent refinement; and
based on the received further supplementary search criterion, selectively displaying the device data corresponding to the supplementary search criterion for the required field device after subsequent start of the search by the user.

2. The method as claimed in claim 1, wherein for inputting the supplementary search criterion into the search field, fitting hit designations of specifications actually present in the automation system and corresponding to the supplementary search criterion are generated and displayed in an associated result list.

3. The method as claimed in claim 1, wherein the selected hit designation is displayed in the refinement search field, and
wherein the supplementary search criterion is input in the form of a suffix to the selected hit designation.

4. The method as claimed in claim 1, wherein the supplementary search criterion is displayed in a result list associated with the refinement search field.

5. The method as claimed in claim 1, wherein the device data corresponding to the supplementary search criterion of the required field device are displayed in the form of a result representation field linked to the device data by a link.

6. An apparatus for the multi-stage interactive locating and utilizing of device data in a networked automation system, the apparatus comprising:
an information fetching unit having an input means, and a monitor configured to display an input mask including a graphical search field, wherein the information fetching unit is confgiured to:
receive a designation input by a user via the input means to the graphical search field of the input mask displayed by the monitor, a field device present in the communication network of the automation system;
generate and display, during the input of the designation into the search field, fitting hit designations of field devices actually present in the automation system, in an associated result list;
receive at least one further supplementary search criterion relating to the selected field device into at least one of the search field and an adjacent refinement search field of the input mask; and
based on the received further supplementary search criterion, display the device data corresponding to the supplementary search criterion for the required field device selectively after the start of the search by the user.

7. The apparatus as claimed in claim 6, wherein the information fetching unit is configured to display, for inputting the supplementary search criterion in the search field, a result list allocated to the supplementary search criterion, with fitting hit designations of specifications actually present in the automation system and corresponding to the supplementary search criterion.

8. The apparatus as claimed in claim 6, wherein the refinement search field displays the selected designation, and
wherein the supplementary search criterion is inputtable in the form of a suffix thereto in the refinement search field .

9. The apparatus as claimed in claim 6, wherein the information fetching unit is configured to display a result list allocated to the refinement search field for inputting the supplementary search criterion.

10. The apparatus as claimed in claim 6, wherein pictograms for visual identification are in each case allocated to the device data in the result representation field.

11. The apparatus as claimed in claim 10, wherein the pictograms represent at least one of the device type of the field device and a file format of the device data.

12. A non-transitory computer-readable recording medium having a computer program recorded thereon that causes a processor of an information fetching unit to execute operations for the multi-stage interactive locating and utilizing of device data in a networked automation system, the operations comprising:
receiving, by a user, an input from a central location by keyboard in a graphical search field of an input mask displayed by a monitor of the information fetching unit, a designation of a field device present in the communication network of the automation system;
generating and displaying fitting hit designations of field devices actually present in the automation system in an associated result list;
receiving, in the input mask, a selection of the required field device;
after selection of the required field device, receiving at least one further supplementary search criterion relating to the selected field device entered into at least one of the search field and an adjacent refinement search field of the input mask in a subsequent refinement; and
based on the received further supplementary search criterion, selectively displaying the device data corresponding to the supplementary search criterion for the required field device after subsequent start of the search by the user.
